(19) United States
(12) Patent Application Publication
(10) Pub. No.: US 2019/0084634 A1
(43) Pub. Date: Mar. 21, 2019

(54) SWITCHING LEVER ON ARCHED HANDLE FOR ADJUSTING HEIGHT OF SEAT TUBE

(71) Applicant: HSIN LUNG ACCESSORIES CO., LTD., HSINCHU COUNTY (TW)

(72) Inventor: HSUEH-SEN LIAO, HSINCHU COUNTY (TW)

(21) Appl. No.: 15/980,781

(22) Filed: May 16, 2018

(30) Foreign Application Priority Data
Sep. 21, 2017 (TW) 106214088

(51) Int. Cl. B62J 1/08; F15B 15/14

(52) U.S. Cl. CPC B62J 1/08; B62J 2001/085; F15B 15/14

(57) ABSTRACT

A switching lever on an arched handle for adjusting a height of a seat tube has a binding ring, a connection part and a shifter. The binding ring is installed on the arched handle and connected to the shifter via the connection part. The connection part has a pivot part to which the shifter is connected via a first bolt, and the shifter is rotated in a clockwise or counterclockwise direction via the pivot part. The connection part and the shifter respectively have a line piercing hole and a line holding section, so as to fix a control line of an adjustable seat tube. The control line is held by a second bolt. Accordingly, a height of the adjustable seat tube is controlled by the shifter, and present disclosure has several advantages, such as usage convenience.

### BACKGROUND

### 1. Technical Field

The present disclosure relates to a control structure, in particularly to, a switching lever for adjusting a height of a seat tube, being installed on an arched handle, and specifically relates to an adjustment structure which the switching lever adjusts a height of the seat tube to change a height of the saddle of a bicycle.

### 2. Description of Related Art

The height of the saddle of the bicycle is not only one factor related to sport damage reduction of the rider, but also one factor related to efficiency of force saving and speed acceleration under the case that the rider bikes with the correct riding pose. To meet the requirements of different heights of the riders and to consider the economic efficiency of manufacturing, the seat tube which can be used to adjust the height of the saddle of the bicycle is the important design issue for the manufacturers recently.

The current structure for adjusting the height of the saddle is mainly formed by a height adjustment apparatus disposed between the seat tube and the saddle standpipe, and the height adjustment apparatus performs a linear displacement to form the relative variation of both positions associated with the seat tube and the saddle standpipe, so as to achieve the function of the height adjustment. The height adjustment apparatus of such kind can be categorized into a mechanic type and a gas hydraulic type according to its generated actuation force. The height adjustment apparatus of the mechanic type utilizes the mechanism properties to generate the actuation force to adjust the relative height positions between the seat tube and the saddle standpipe. The height adjustment apparatus of the gas hydraulic type utilizes the gas pressure component or oil pressure component (or both of them) to generate actuation force to adjust the relative height positions between the seat tube and the saddle standpipe.

Referring to FIG. 1, the general handle of the bicycle is mostly the straight handle (101), and the user can install components of a lamp, a derailleur shifter and a bell on the handle. Another handle of the bicycle is shown as FIG. 2, FIG. 8 and FIG. 10, and this handle is an arched handle (102) formed by an arched section (1022) and a straight section (1021). As shown in FIG. 8, the user can use his/her two hands to hold straight section (1021) when generally riding. When increasing the speed, the two hands of the users are disposed on the position of the arched section (1022) as shown in FIG. 9, such that the body of the user is curved to the pose being adaptive to increase the pedaling speed, and by the biking skill of treading or sprinting, the bicycle can accelerate, corner and climb. When the speed is stable, the user can put his/her hands on the position shown in FIG. 10, for resting.

However, the outline of the arched handle (102) is not suitable for installing components of the bicycle on the straight section (1021). In particularly, the handle has been installed with the components of the lamp, the derailleur shifter and the bell, and if the adjustment lever is installed on the straight section (1021), it may make the components on the handle of the bicycle messy and cause usage inconvenience. Furthermore, to meet the different road condition, the user must hold the terminal ends or middle ends of the arched section (1022) of the arched handle, and it may cause biking inconvenience if the adjustment lever is installed on the straight section (1021).

### SUMMARY

One objective of the present disclosure is to improve the deficiency of the related art, and the main technology and goal of the present disclosure are to install a binding ring on an arched handle, wherein the binding ring is extended to have a pivot part, and a rotatable shifter is installed on the pivot part. The lever is pressed dependent on the requirement to make the seat tube connected to the bicycle frame adjust its height or position, thus providing usage convenience.

The structure for achieving the above objective mainly comprises: a binding ring, mainly formed by a holding sheet being bended, wherein the binding ring is installed on the arched handle; a connection part, having a base body and a pivot part being extended from the base body, wherein the base body is connected to the binding ring; and a shifter, having a through hole, being screwed by a bolt via the through hole, wherein the shifter is pivotally rotated in respect to the pivot part of the connection part.

In the above structure, the switching lever of an arched handle for adjusting a height of a seat tube can be further formed by the components as follows: a binding ring, mainly formed by a holding sheet being bended, wherein each of two ends of the binding ring is installed with a hole, the binding ring is installed on an arched handle, and interior of the binding ring is installed with an inner screw section; a connection part, having a base body and a pivot part being extended from the base body, wherein the base body is connected to the binding ring, the pivot part having a connection hole, the tightening part is installed at one side of connection hole being neighboring to the binding ring, and the base body is installed with a line piercing hole thereon to provide a control line to pierce into and be fixed, so as to adjust and control an adjustable seat tube; and a shifter, having a through hole, wherein the shifter is installed on the pivot part via the through hole, a bolt pierces into the connection hole of the connection part and is screwed by the inner screw section, the shifter has a first shifting section and a second shifting section to make the pivot part function as a boundary line between the first shifting section and the second shifting section, such that the first shifting section and the second shifting section are rotated in respect to the pivot part, and the shifter has a line holding section, wherein the control line pierces into the line piercing hole and is fixed and held on the line holding section via a second bolt.

In the embodiment of the present disclosure, the adjustable seat tube further comprises a pressure switch, the pressure switch is connected to another end of the control line, and a position of a telescopic rod in the adjustable seat tube is adjusted via a tension of the control line.

In the embodiment of the present disclosure, the shifter further comprises a line holding section for allowing the second bolt to press the line holding section and to rotate a position of the shifter, so as to control the height of the adjustable seat tube.

In the embodiment of the present disclosure, the adjustable seat tube is an adjustable seat tube structure of a gas hydraulic type.

In the embodiment of the present disclosure, the shifter is installed on the pivot part via the through hole.

In the embodiment of the present disclosure, the control line pierces into the line piercing hole, and is held and fixed on the line holding section via a second bolt.

In the embodiment of the present disclosure, the inner screw section is a tightening part, wherein the tightening part is installed on the side of connection hole being neighboring to the binding ring of the connection hole, wherein the shifter and the tightening part are screwed.

In the embodiment of the present disclosure, the tightening part is provided to screw the first bolt, and to drive the shifter and the connection part to move forward the binding ring.

In the embodiment of the present disclosure, the base body is connected to the binding ring.

According to the technical means of the present disclosure, the advantages of the present disclosure is briefly listed as follows: (1) the structure of the present disclosure mainly utilize the binding ring to be fixed on the arched handle, and then a connection part having a pivot part is installed on the binding ring, so as to sleeve the shifter to the pivot part, and to make the shifter be able to rotate in a clockwise or counterclockwise direction, such that the structure of the present disclosure can be used to quickly adjust the position of the seat tube according to the requirement of the user, to increase the pedaling efficiency is increased, and to prevent the sport damage.

### BRIEF DESCRIPTION OF THE DRAWINGS

FIG. 1 is a schematic diagram showing a structure of a bicycle having a conventional straight handle.

FIG. 2 is a schematic diagram showing a structure of a bicycle having a conventional arched handle.

FIG. 3 is a schematic diagram showing a system of the present disclosure.

FIG. 4 is a three dimensional diagram showing structure decomposition of a switching lever of the present disclosure.

FIG. 5 is a sectional view of the system structure of FIG. 3.

FIG. 6 is a schematic diagram showing assembling of the present disclosure.

FIG. 7 is a schematic diagram showing a usage state of the present disclosure.

FIG. 8 through FIG. 13 are schematic diagrams showing an usage operation of an arched handle of the present disclosure.

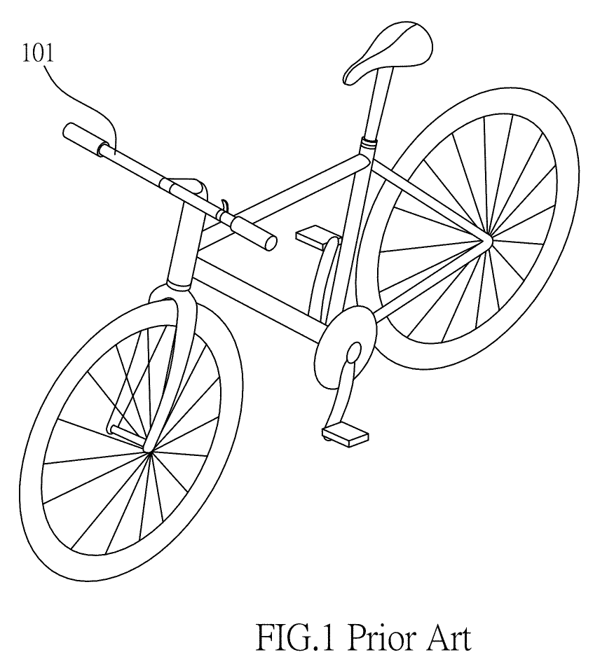

### DESCRIPTION OF THE EXEMPLARY EMBODIMENTS

To facilitate understanding of the present disclosure, the following descriptions are provided to illustrate exemplary embodiments of the present disclosure together with drawings.

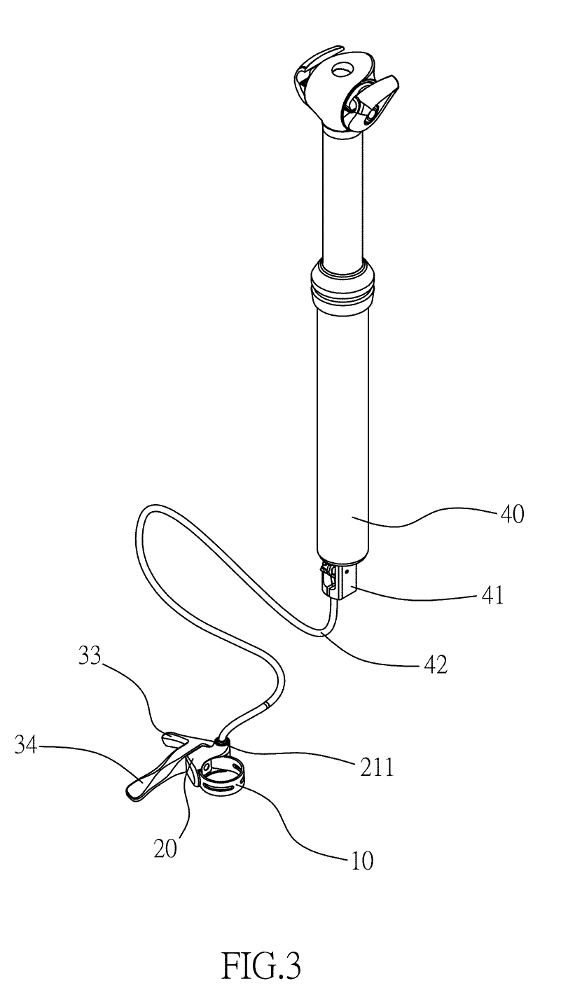

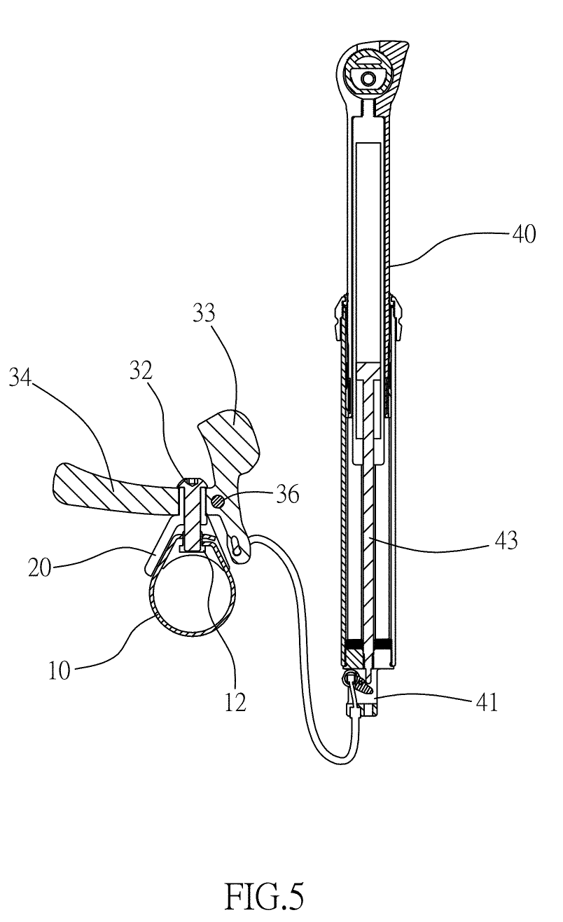

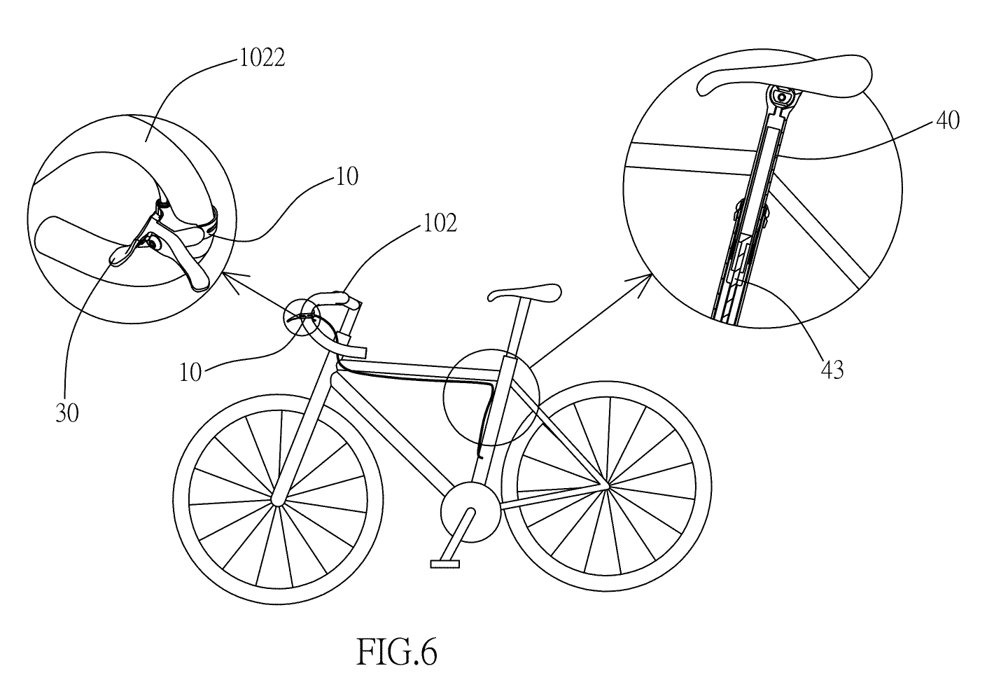

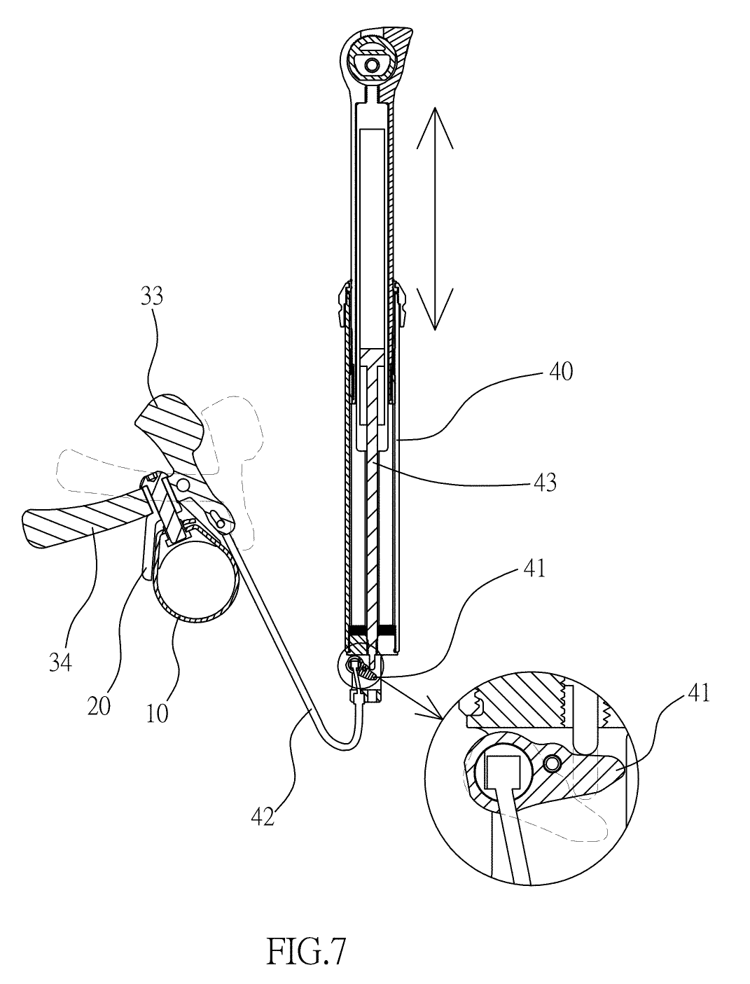

Referring to FIG. 3 through FIG. 7, a switching lever of an arched handle for adjusting a height of a seat tube in the present disclosure mainly comprises:

a binding ring (10), mainly formed by a holding sheet (11) being bended, wherein each of two ends of the binding ring (10) is installed with a hole (111), the binding ring (10) is installed on an arched handle, interior of the binding ring (10) is installed with an inner screw section (12), and the inner screw section (12) can be installed on the inner wall surface of the hole (111).

a connection part (20), having a base body (21) and a pivot part (22) being extended from the base body (21), wherein the base body (21) is connected to the binding ring (10), the pivot part (22) having a connection hole (221), the inner screw section (12) is installed at one side of connection hole (221) being neighboring to the binding ring (10), and the base body (21) is installed with a line piercing hole (211) thereon to provide a control line (42) to pierce into and be fixed, so as to adjust and control an adjustable seat tube (40); and

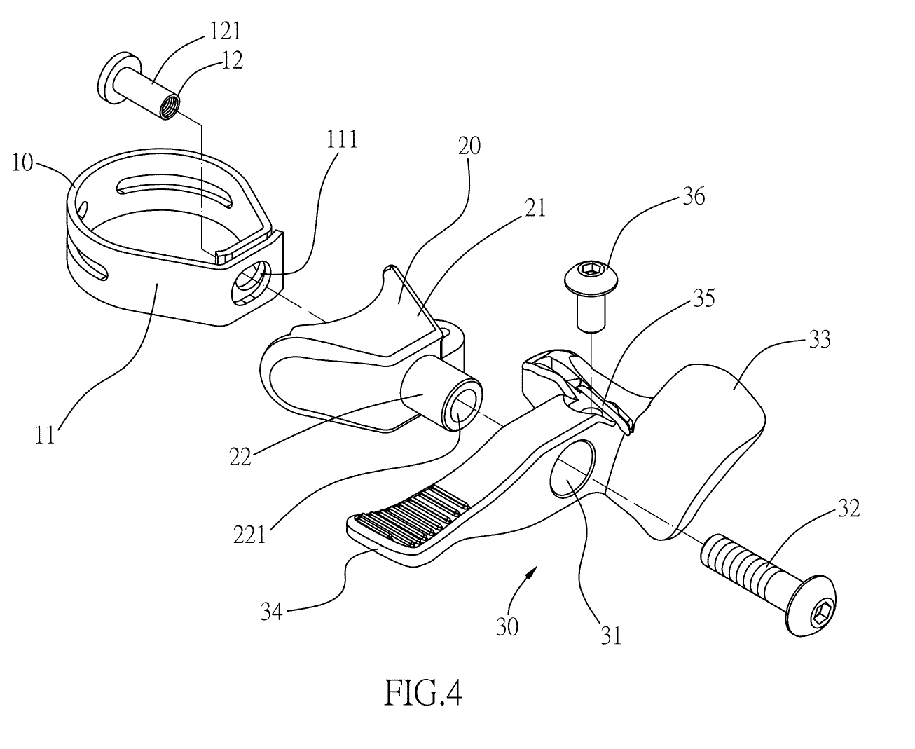

a shifter (30), having a through hole (31), wherein a first bolt (32) pierces into the connection hole (221) of the connection part (22) via the through hole (31) and is screwed by the inner screw section (12), so as to install the shifter (30) on the pivot part (22), and the shifter (30) has a first shifting section (33) and a second shifting section (34) to make the pivot part (22) function as a boundary line between the first shifting section (33) and the second shifting section (34), such that the first shifting section (33) and the second shifting section (34) are rotated in respect to the pivot part (22); the shifter (30) further has a line holding section (35) allowing the control line (42) to pierce into, and then to be fixed and held on the line holding section (35) by a second bolt (36); in an embodiment of the present disclosure, as shown in FIG. 4, the inner screw section (12) is a tightening part (121), wherein the tightening part (121) is installed on the side of connection hole (221) being neighboring to the binding ring (10) of the connection hole (221), such that the tightening part (121) is correspondingly screwed by the first bolt (32), and the shifter (30) and the tightening part (121) are screwed.

Still referring to FIG. 3 through FIG. 7, the action features of the present disclosure are characterized in: the structure of the present disclosure is mainly formed by a holding sheet (11) being bended, the binding ring (10) is installed on an arched handle; the connection part (20) has a base body (21) and a pivot part (22) being extended from the base body (21), and the base body (21) is connected to the binding ring (10); the shifter (30) has a through hole (31), the shifter (30) is installed on the pivot part (22) on the through hole (31), and screwed by a bolt, and shifter (30) is pivotally rotated in respect to the pivot part (22) of the connection part (20).

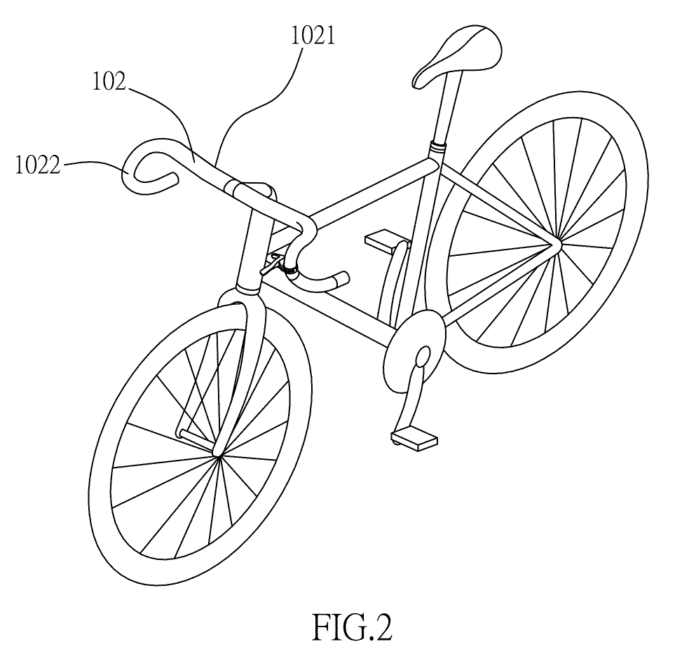

Referring to FIG. 2 through FIG. 6, assembling of the present disclosure can be illustrated. Firstly, the holding sheet (11) of the binding ring (10) is installed on the arched handle, the tightening part (121) pierces into the hole (111), the connection part (20) is sleeved to the binding ring (10), the shifter (30) is sleeved on the pivot part (22) and screwed by the first bolt (32), the interior of the tightening part (121) has the inner screw section (12) to drive the shifter (30) and the connection part (20) to move forward the binding ring (10) when being screwed, such that the three components can be compactly fixed to the arched handle; next, the control line (42) of adjustable seat tube (40) is taken, the control line (42) pierces into the line piercing hole (211) of the base body (21) of the connection part (20), the control line (42) is pulled downward, the shifter (30) has the line holding section (35) thereon, and the control line (42) is disposed into the line holding section (35) and screwed on the line holding section (35) via the second bolt (36), such that the control line (42) is held on the line holding section (35) of the shifter (30).

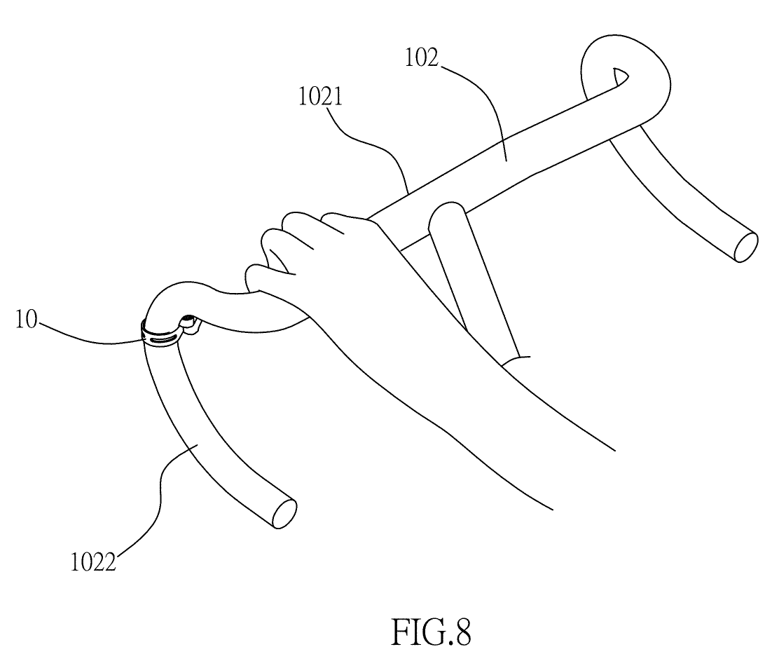

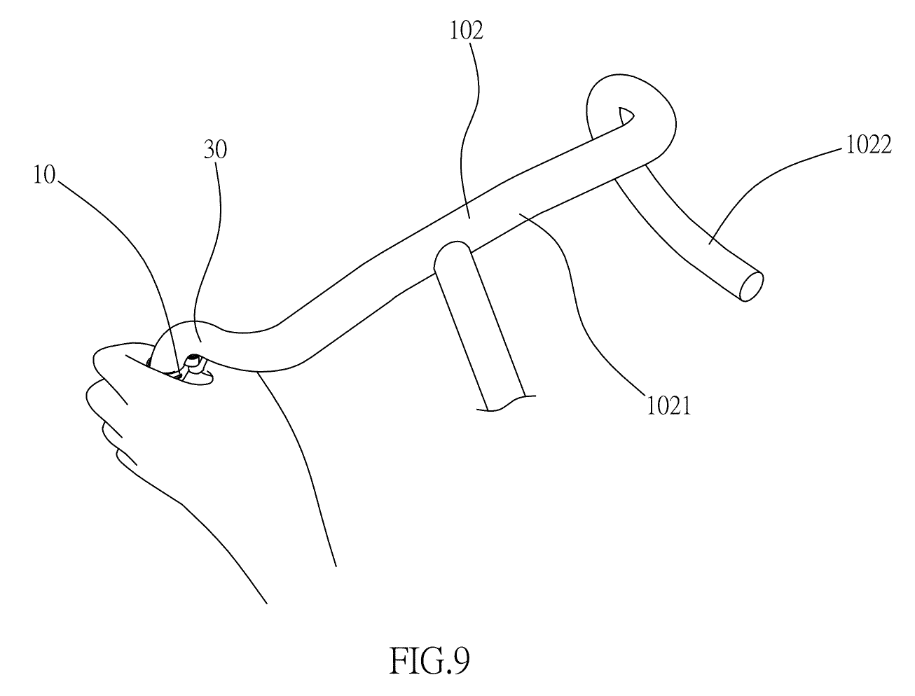

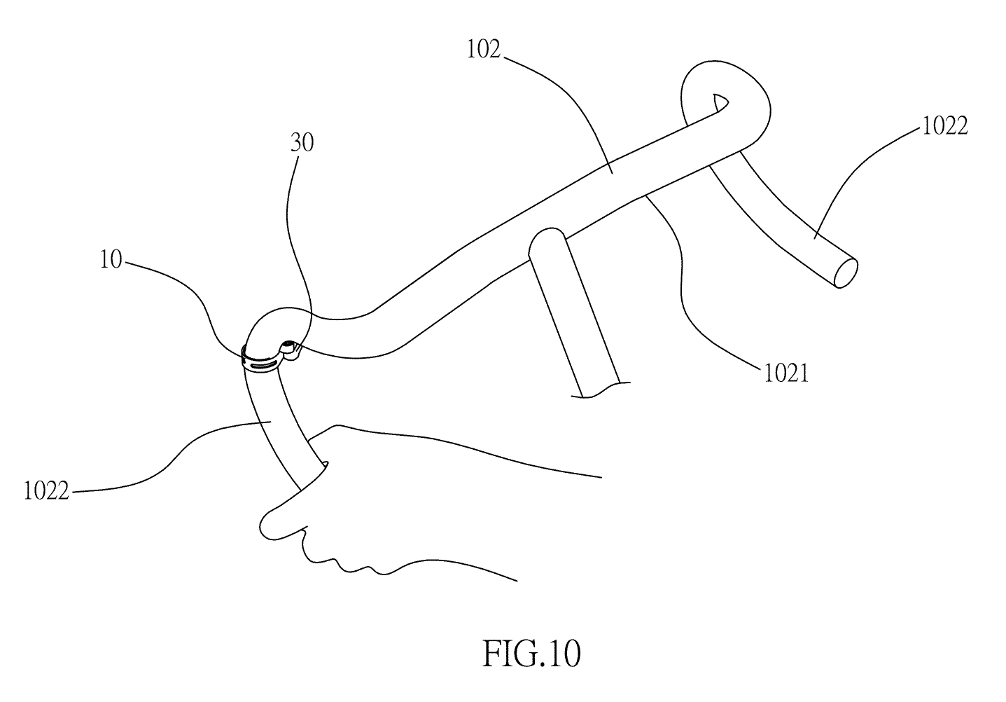

Referring to FIG. 2 through FIG. 10, regardless the pose of the user when riding the bicycle, the height of the seat tube can be always adjusted. Firstly, the second bolt (36) presses the line holding section (35), and the user must push the first shifting section (33) or the second shifting section (34) to rotate the shifter in the clockwise or counterclockwise direction to change the length of the control line (42). When the length of the control line (42) changes, the pressure switch (41) under the adjustable seat tube (40) changes since another side of the control line (42) is connected to the adjustable seat tube (40).

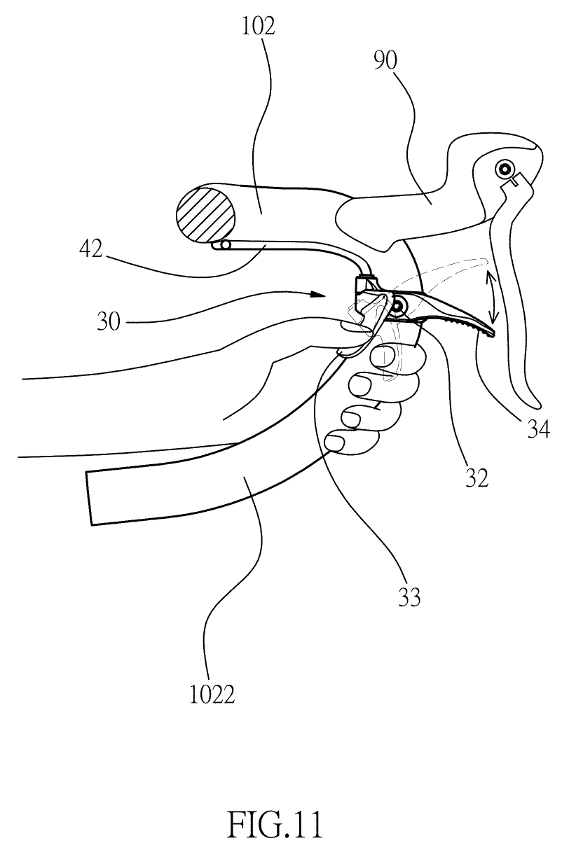

Referring to FIG. 11, FIG. 11 is another schematic diagram showing the usage operation of the arched handle (102) of the present disclosure. When the rider bikes, the biker can use the hands thereof to hold the arched section (1022) of the arched handle (102). When the height of the saddle should be adjusted, the biker can use the thumb thereof to press the first shifting section (33), such that the first shifting section (33) of the shifter (30) is rotated by the first bolt (32), and the control line (42) can release the pressure switch (41). At the same time, the position of the telescopic rod (43) of the adjustable seat tube (40) is lowered, so as to adjust the height of the saddle.

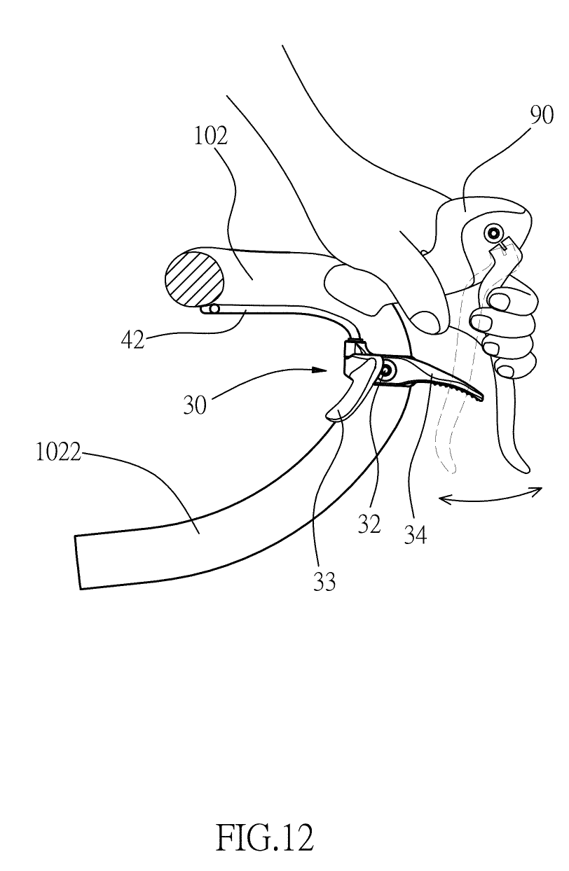

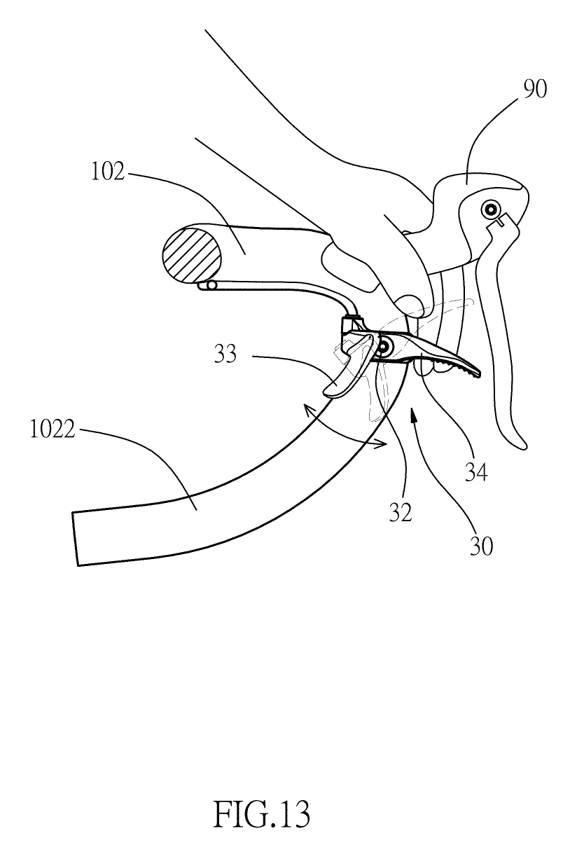

Referring to FIG. 12 and FIG. 13 simultaneously, FIG. 12 and FIG. 13 are other schematic diagrams showing the usage operation of the arched handle (102) of the present disclosure. When the rider bikes, the user can put the palm on the brake stem (90). When the height of the saddle should be adjusted, the user can use the fingers thereof (the index and middle fingers) to toggle the second shifting section (34) to rotate the first bolt (32), such that the control line (42) compresses the pressure switch (41). At the same time, the position of the telescopic rod (43) of the adjustable seat tube (40) is raised, so as to adjust the height of the saddle. When the user confirms the height of the adjustable seat tube (40) is proper, the user can use the hand tool to screw the second bolt (36) to be tight, so as to complete the work of the height adjustment of the adjustable seat tube (40).

By using the above structure, the present disclosure can obtain the effects as follows: since the height adjustment switch of the convention adjustable seat tube (40) of the arched handle is most installed on the straight section, it causes the usage inconvenience, but by using the structure of the present disclosure to rotate the shifter (30), the height of the adjustable seat tube (40) can be adjusted in time, thus achieving several advantages, such as usage convenience.

To sum up, the structure provided by the present disclosure has been not anticipated by publications or used in public, which meets patentability of the invention. Examination of the present disclosure is respectfully requested, as well as allowance of the present disclosure.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A switching lever on an arched handle for adjusting a height of a seat tube, mainly comprising:
a binding ring, mainly formed by a holding sheet being bended, wherein the binding ring is installed on the arched handle;
a connection part, having a base body and a pivot part being extended from the base body; and
a shifter, having a through hole, being screwed by a first bolt, wherein the shifter is pivotally rotated in respect to the pivot part of the connection part.

2. A switching lever on an arched handle for adjusting a height of a seat tube, mainly comprising:
a binding ring, mainly formed by a holding sheet being bended, wherein each of two ends of the binding ring is installed with a hole, the binding ring is installed on an arched handle, and interior of the binding ring is installed with an inner screw section;
a connection part, having a base body and a pivot part being extended from the base body, wherein the base body is connected to the binding ring, the pivot part having a connection hole, the inner screw section is installed at one side of connection hole being neighboring to the binding ring, and the base body is installed with a line piercing hole thereon to provide a control line to pierce into and be fixed, so as to adjust and control an adjustable seat tube; and
a shifter, having a through hole, wherein a first bolt pierces into the connection hole of the connection part via the through hole and is screwed by the inner screw section, and the shifter has a first shifting section and a second shifting section to make the pivot part function as a boundary line between the first shifting section and the second shifting section, such that the first shifting section and the second shifting section are rotated in respect to the pivot part.

3. The switching lever on the arched handle for adjusting the height of the seat tube according to claim 2, wherein the adjustable seat tube further comprises a pressure switch, the pressure switch is connected to another end of the control line, and a position of a telescopic rod in the adjustable seat tube is adjusted via a tension of the control line.

4. The switching lever on the arched handle for adjusting the height of the seat tube according to claim 2, wherein the shifter further comprises a line holding section for allowing a second bolt to press the line holding section and to rotate a position of the shifter, so as to control the height of the adjustable seat tube.

5. The switching lever on the arched handle for adjusting the height of the seat tube according to claim 4, wherein the adjustable seat tube is an adjustable seat tube structure of a gas hydraulic type.

6. The switching lever on the arched handle for adjusting the height of the seat tube according to claim 1, wherein the shifter is installed on the pivot part via the through hole.

7. The switching lever on the arched handle for adjusting the height of the seat tube according to claim 4, wherein the shifter is installed on the pivot part via the through hole.

8. The switching lever on the arched handle for adjusting the height of the seat tube according to claim 4, wherein the control line pierces into the line piercing hole, and is held and fixed on the line holding section via the second bolt.

9. The switching lever on the arched handle for adjusting the height of the seat tube according to claim 2, wherein the inner screw section is a tightening part, wherein the tightening part is installed on the side of connection hole being neighboring to the binding ring of the connection hole, wherein the shifter and the tightening part are screwed.

10. The switching lever on the arched handle for adjusting the height of the seat tube according to claim 8, wherein the tightening part is provided to screw the first bolt, and to drive the shifter and the connection part to move forward the binding ring.

11. The switching lever on the arched handle for adjusting the height of the seat tube according to claim 1, wherein the base body is connected to the binding ring.
